(19) United States
(12) Patent Application Publication
(10) Pub. No.: US 2026/0204174 A1
(43) Pub. Date: Jul. 16, 2026

(54) GENERATIVE TRAINING SCENARIO SIMULATION TESTING SYSTEM

(71) Applicant: AI Next Mine CO., LTD., Taichung City (TW)

(72) Inventor: Chiu-Liang LIU, Taichung City (TW)

(73) Assignee: AI Next Mine CO., LTD., Taichung City (TW)

(21) Appl. No.: 19/445,248

(22) Filed: Jan. 9, 2026

(30) Foreign Application Priority Data
Jan. 13, 2025 (TW) 114101353

(51) Int. Cl. G09B 9/00; G06V 10/764; G06V 40/20; G09B 7/02; G06V 10/82

(52) U.S. Cl. CPC G09B 9/00; G06V 10/764; G06V 40/20; G09B 7/02; G06V 10/82

(57) ABSTRACT

A generative training scenario simulation testing system is provided to be used at a test site, and includes a camera device to capture a test image corresponding to the test site in real time, and a processing device. The processing device cooperates with a first server end and a second server end to generate an assessment result based on the test image in relation to SOP information using a pre-trained object detection model, a pre-trained action detection model, a pre-trained behavior classification model, and a pre-trained behavior assessment model, and to generate a text-based exam based on a prompt template and the assessment result using a natural language generation model.

### CROSS-REFERENCE TO RELATED APPLICATION

This application claims priority to Taiwanese Invention Patent Application No. 114101353, filed on January 13, 2025, the entire disclosure of which is incorporated by reference herein.

### FIELD

The disclosure relates to a testing system, and more particularly to a generative training scenario simulation testing system.

### BACKGROUND

In general, newly recruited personnel typically require training and assessment conducted by experienced staff when entering a workplace. For example, mechanical maintenance personnel not only need to possess a certain level of professional knowledge but also must demonstrate practical on-site operational skills.

However, due to workforce shortages, it is often difficult to allocate experienced personnel specifically for the purpose of training and assessing new recruits. Therefore, training newly hired personnel efficiently has become an important issue that cannot be overlooked.

### SUMMARY

Therefore, an object of the disclosure is to provide a generative training scenario simulation testing system that can efficiently training a trainee.

According to some embodiments of the disclosure, the generative training scenario simulation testing system is to be used at a test site, and is communicatively coupled to a first server end and a second server end. The first server end stores a pre-trained object detection model, a pre-trained action detection model, a pre-trained behavior classification model, a pre-trained behavior assessment model, and standard operating procedure (SOP) information. The second server end stores a natural language generation (NLG) model. The generative training scenario simulation testing system includes a camera device and a processing device. The camera device is disposed at the test site, and is configured to capture a test image corresponding to the test site in real time. The processing device includes a data collection module, a storage module, and a computation module. The data collection module is communicatively coupled to the camera device for receiving the test image. The storage module stores a prompt template. The computation module is electrically coupled to the data collection module and the storage module, and is communicatively coupled to the first server end and the second server end. The computation module is configured to receive the test image from the data collection module, transmit the test image to the first server end, and receive an assessment result from the first server end. The assessment result is generated based on the test image in relation to the SOP information, jointly by the pre-trained object detection model, the pre-trained action detection model, the pre-trained behavior classification model, and the pre-trained behavior assessment model. The computation module is configured to transmit the prompt template and the assessment result to the second server end, and receive a text-based exam from the second server end, the text-based exam being generated based on the prompt template and the assessment result by the NLG model.

According to some embodiments of the disclosure, the generative training scenario simulation testing system is to be used at a test site, and includes a camera device and a processing device. The camera device is disposed at the test site, and is configured to capture a test image corresponding to the test site in real time. The processing device includes a data collection module, a storage module, and a computation module. The data collection module is communicatively coupled to the camera device for receiving the test image. The storage module stores a prompt template, standard operating procedure (SOP) information, a built-in pre-trained object detection model, a built-in pre-trained action detection model, a built-in pre-trained behavior classification model, a built-in pre-trained behavior assessment model, and a built-in natural language generation (NLG) model. The computation module is electrically coupled to the data collection module and the storage module. The computation module is configured to receive the test image from the data collection module, and to use the built-in pre-trained object detection model, the built-in pre-trained action detection model, the built-in pre-trained behavior classification model, and the built-in pre-trained behavior assessment model to jointly generate an assessment result based on the test image in relation to the SOP information. The computation module is configured to use the built-in NLG model to generate a text-based exam based on the prompt template and the assessment result.

According to some embodiments of the disclosure, the generative training scenario simulation testing system is to be used at a test site, and includes a camera device and a computerized system. The camera device is disposed at the test site, and is configured to capture a test image corresponding to the test site in real time. The test image shows a trainee undergoing a simulated mechanical maintenance training at the test site. The computerized system is communicatively coupled to the camera device for receiving the test image, and stores a prompt template, a pre-trained object detection model, a pre-trained action detection model, a pre-trained behavior classification model, a pre-trained behavior assessment model, standard operating procedure (SOP) information related to the simulated mechanical maintenance training, and a natural language generation (NLG) model. The computerized system is configured to use the pre-trained object detection model, the pre-trained action detection model, the pre-trained behavior classification model, and the pre-trained behavior assessment model to generate an assessment result based on the test image in relation to the SOP information. The computerized system is configured to use the NLG model to generate a text-based exam based on the prompt template and the assessment result, and to perceivably output the text-based exam for the trainee to answer.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a first embodiment of a generative training scenario simulation testing system according to the disclosure.

FIG. 2 is a block diagram illustrating a second embodiment of the generative training scenario simulation testing system according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

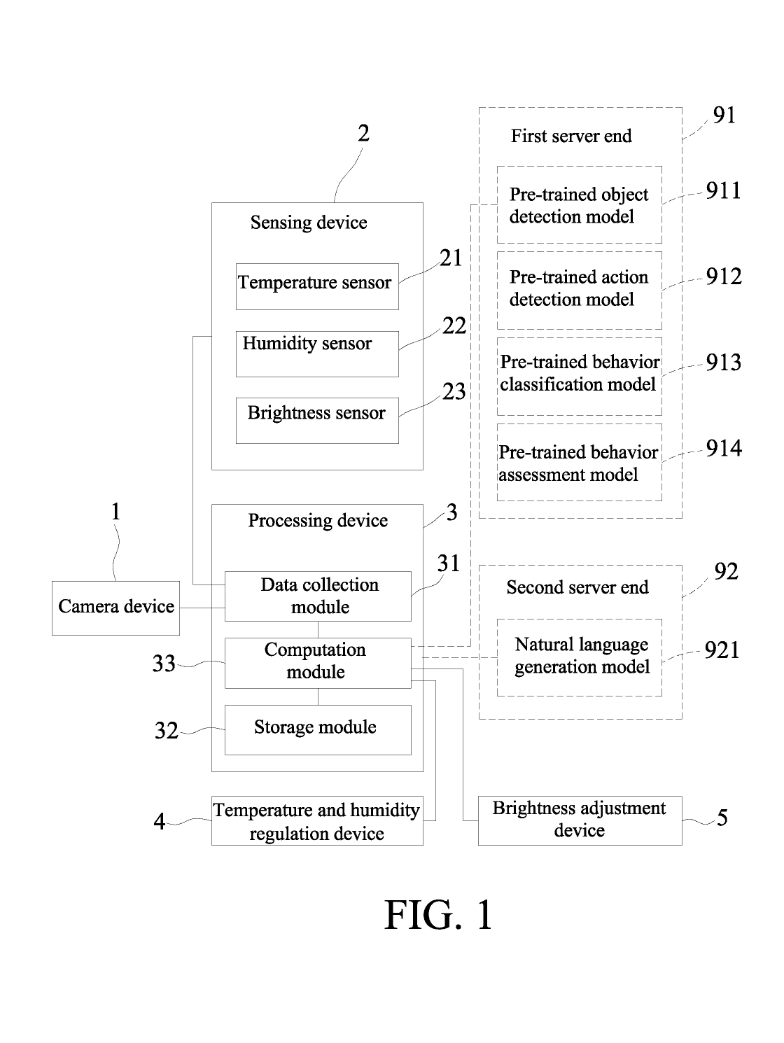

Referring to FIG. 1, a first embodiment of a generative training scenario simulation testing system according to this disclosure is adapted to be used at a test site (not shown), and is communicatively coupled to a first server end 91 and a second server end 92. The first server end 91 stores a pre-trained object detection model 911, a pre-trained action detection model 912, a pre-trained behavior classification model 913, a pre-trained behavior assessment model 914, standard operating procedure (SOP) information, and an efficiency evaluation algorithm. The second server end 92 stores a natural language generation (NLG) model 921.

In this embodiment, the test site is a simulation examination area provided for a trainee to undergo a simulated mechanical maintenance training. The pre-trained object detection model 911 is implemented using conventional object detection algorithms such as YOLO or Faster Region-based Convolutional Neural Networks (R-CNN). The pre-trained object detection model 911 is trained using training images with annotations, thereby achieving accurate object detection and recognition capabilities. The pre-trained action detection model 912 is implemented using conventional open-source tools such as OpenPose or Mediapipe. The pre-trained behavior classification model 913 is developed based on conventional deep learning models such as Convolutional Neural Networks (CNNs) or Recurrent Neural Networks (RNNs), thereby segmenting a sequence of images into different behavior segments. The pre-trained behavior assessment model 914 is developed based on a long short-term memory (LSTM) network model, thereby determining differences between each behavior segment and the SOP information. The simulated mechanical maintenance training may be classified into multiple operation steps in the SOP information. For each operation step, the SOP information may include reference object features, reference action features and reference behavior features that are extracted using the pre-trained object detection model 911, the pre-trained action detection model 912, the pre-trained behavior classification model 913, and/or the pre-trained behavior assessment model 914, from images corresponding to a complete practical operation of the simulated mechanical maintenance training performed by experts in the relevant field, such as the mechanical maintenance field. The efficiency evaluation algorithm employs a dynamic time warping (DTW) method. The NLG model 921 is implemented using a conventional generative pre-trained transformer (GPT) model combined with a mechanical-domain corpus, and fine-tunes prompts through tools provided by the ChatGPT application programming interface (API) to generate different text-based exams.

The first embodiment of the generative training scenario simulation testing system includes a camera device 1, a sensing device 2, a processing device 3, a temperature and humidity regulation device 4, and a brightness adjustment device 5.

The camera device 1 is disposed at the test site, and is configured to capture a test image corresponding to the test site in real time. In this embodiment, the camera device 1 is implemented using a camera of a closed-circuit television (CCTV) system, but this disclosure is not limited in this respect.

The sensing device 2 is disposed at the test site, and includes a temperature sensor 21, a humidity sensor 22, and a brightness sensor 23. The temperature sensor 21 is configured to sense a temperature of the test site in real time, and to generate temperature data corresponding to the temperature of the test site thus sensed. The humidity sensor 22 is configured to sense a humidity of the test site in real time, and to generate humidity data corresponding to the humidity of the test site thus sensed. The brightness sensor 23 is configured to sense a brightness of the test site in real time, and to generate brightness data corresponding to the brightness of the test site thus sensed. In some variations of this embodiment, the sensing device 2 may include only one or two of the temperature sensor 21, the humidity sensor 22, and the brightness sensor 23, and this disclosure is not limited in this respect.

The processing device 3 includes a data collection module 31, a storage module 32, and a computation module 33. The data collection module 31 is communicatively coupled to the camera device 1, the temperature sensor 21, the humidity sensor 22, and the brightness sensor 23, and may be implemented using, for example but not limited to, a wired communication module (e.g., an Ethernet module, a serial port module, a CAN bus module, etc.), a wireless communication module (e.g., a Bluetooth module, a Wi-Fi module, etc.), or any combination thereof. The storage module 32 stores a prompt template and standard environment data, and may be implemented using, for example, a hard disk drive, a solid state drive, flash memory, other types of non-volatile storage media, or any combination thereof. The standard environment data is related to a standard test site, and may include, for example but not limited to, data of a temperature, a humidity, and/or a brightness of the standard test site. The computation module 33 is communicatively coupled to the first server end 91 and the second server end 92, and may be implemented to include, for example, a processor, a communication module (e.g., a Wi-Fi module, an Ethernet module, etc.), other suitable components, and so on.

In this embodiment, the processing device 3 is implemented by an integrated circuit, a computer, or a server having computing and storage capabilities, and exemplarily includes hardware components (not shown), such as a processor, a memory, communication circuitry, an input interface (e.g., a keyboard, a mouse, a touch screen, a microphone, etc.), and an output interface (e.g., a display screen, a speaker, etc.).

The temperature and humidity regulation device 4 is disposed at the test site. In this embodiment, the temperature and humidity regulating device 4 may be a smart air-conditioner having Internet of Things (IoT) functionality, and is remotely controlled by the processing device 3 to regulate the temperature and humidity of the test site.

The brightness adjustment device 5 is disposed at the test site. In this embodiment, the brightness adjustment device 5 may be a smart lighting fixture having Internet of Things (IoT) functionality, and is remotely controlled by the processing device 3 to adjust the brightness of the test site.

In operation, the data collection module 31 receives the test image from the camera device 1, and receives at least one of the temperature data, the humidity data or the brightness data from the sensing device 2. Then, the computation module 33 receives the test image and the at least one of the temperature data, the humidity data or the brightness data from the data collection module 31.

Subsequently, the computation module 33 controls the temperature and humidity regulation device 4 and/or the brightness adjustment device 5 based on the standard environment data and the at least one of the temperature data, the humidity data or the brightness data, thereby adjusting the temperature, the humidity, and/or the brightness of the test site to simulate the temperature, the humidity, and/or the brightness of the standard test site. In one embodiment, the computation module 33 may control the temperature and humidity regulation device 4 based on the temperature data and the temperature of the standard test site as indicated in the standard environment data, thereby adjusting the temperature of the test site to fit the temperature of the standard test site. In one embodiment, the computation module 33 may control the temperature and humidity regulation device 4 based on the humidity data and the humidity of the standard test site as indicated in the standard environment data, thereby adjusting the humidity of the test site to fit the humidity of the standard test site. In one embodiment, the computation module 33 may control the brightness adjustment device 5 based on the brightness data and the brightness of the standard test site as indicated in the standard environment data, thereby adjusting the brightness of the test site to fit the brightness of the standard test site.

The computation module 33 transmits the test image to the first server end 91, and waits to receive an assessment result from the first server end 91. The assessment result is generated based on the test image in relation to the SOP information, jointly by the pre-trained object detection model 911, the pre-trained action detection model 912, the pre-trained behavior classification model 913, and the pre-trained behavior assessment model 914. For example, the test image may be a recorded image of the trainee performing the simulated mechanical maintenance training, and show that the trainee did not securely tighten the screws when fastening them onto a machine. The first server end 91 may use the pre-trained object detection model 911 to identify an object feature (e.g., a hand tool, a screw, etc.) appearing in the test image during a specific time interval, and use the pre-trained action detection model 912 to identify an action feature (e.g., turning a screw) appearing in the test image during the specific time interval. Then, the first server end may use the pre-trained behavior classification model 913 to classify, based on the object feature and the action feature thus identified, the specific time interval of the test image into one of the operation steps in the SOP information. The first server end 91 may subsequently use the pre-trained behavior assessment model 914 to determine whether a behavior feature (e.g., a behavior execution sequence, a behavior execution manner, a behavior execution result, etc.) jointly derived from the object feature and the action feature as identified for the specific time interval conforms to the corresponding operation step in the SOP information. It is noted that a rule for classifying the specific time interval of the test image may be established during the training of a machine learning algorithm or a neural network that is used to obtain the pre-trained behavior classification model 913. It is noted that a criteria of determining whether a behavior feature jointly derived from the object feature and the action feature as identified for the specific time interval of the test image conforms to the corresponding operation step in the SOP information may be established during the training of a machine learning algorithm or a neural network that is used to obtain the pre-trained behavior assessment model 914. In this embodiment, the pre-trained behavior assessment model 914 may determine whether the behavior feature jointly derived from the object feature and the action feature is “correct” (i.e., conforming to the corresponding operation step in the SOP information) or “incorrect” (i.e., not conforming to the corresponding operation step in the SOP information). In a case where the behavior feature jointly derived from the object feature and the action feature is determined to be “correct,” the first server end 91 may further use the efficiency evaluation algorithm to calculate a degree of temporal matching between an operation time of the trainee during the specific time interval and a time defined in the SOP information with respect to the corresponding operation step, thereby determining whether the behavior feature jointly derived from the object feature and the action feature falls into an “non-proficient” category (e.g., falling into the “non-proficient” category when the degree of temporal matching is not greater than a predetermined threshold, and not falling into the “non-proficient” category when the degree of temporal matching is greater than a predetermined threshold). Accordingly, the assessment result may indicate that the behavior feature jointly derived from the object feature and the action feature presented during the specific time interval of the test image is “correct,” “incorrect,” or “non-proficient.”

After receiving the assessment result from the first server end 91, the computation module 33 transmits the prompt template and the assessment result to the second server end 92, and waits to receive a text-based exam from the second server end 92, where the second server end 92 uses the NLG model 921 to generate the text-based exam based on the prompt template and the assessment result. The text-based exam corresponds to the prompt template and the assessment result. For instance, the prompt template provided by the computation module 33 may be “Please analyze the following content, and then infer and generate related test questions,” the assessment result may be “the behavior feature of tightening screws is incorrect” or “the behavior feature of tightening screws is non-proficient,” and the second server end 92 may use the NLG model 921 to generate a text-based exam relating to the behavior feature of tightening screws accordingly, and perceivably output the text-base exam (e.g., using a display of the processing device 3 to display the text-based exam) for the trainee to answer, thereby enhancing an understanding level of the trainee regarding operating principles and/or the SOP. After the trainee completes the text-based exam, the trainee may be required to perform the simulated mechanical maintenance training again, thereby obtaining an updated test image and generating an updated assessment result. If the updated assessment result still indicates that the behavior feature presented in the updated test images is “incorrect” or “non-proficient,” an updated text-based exam is subsequently generated based on the prompt template and the updated assessment result, forming a new learning cycle. In this manner, progress achieved in the new round of simulated mechanical maintenance training may be measured relative to the previous round, for example, by reductions in time required or in the number of incorrectness. On the other hand, the text-based exam generated in each round may be recorded by the computation module 33 in the storage module 32 for subsequent analysis, such as identifying operation steps in which incorrectness most frequently occurs. Furthermore, an examiner, a supervisor, or a senior personnel may quickly understand deficiencies of the trainee based on the textual responses to the text-based exams.

Accordingly, the first embodiment may detect “incorrectness” or “non-proficiency” occurring in the test images of practical operations, and dynamically generate corresponding text-based exam for the trainee, thereby reinforcing training focus and improving learning effectiveness. The first embodiment verifies both practical operation capability and background knowledge of the trainee by providing the assessment result together with the text-based exam, thereby enabling more efficient training and assessment of the trainee.

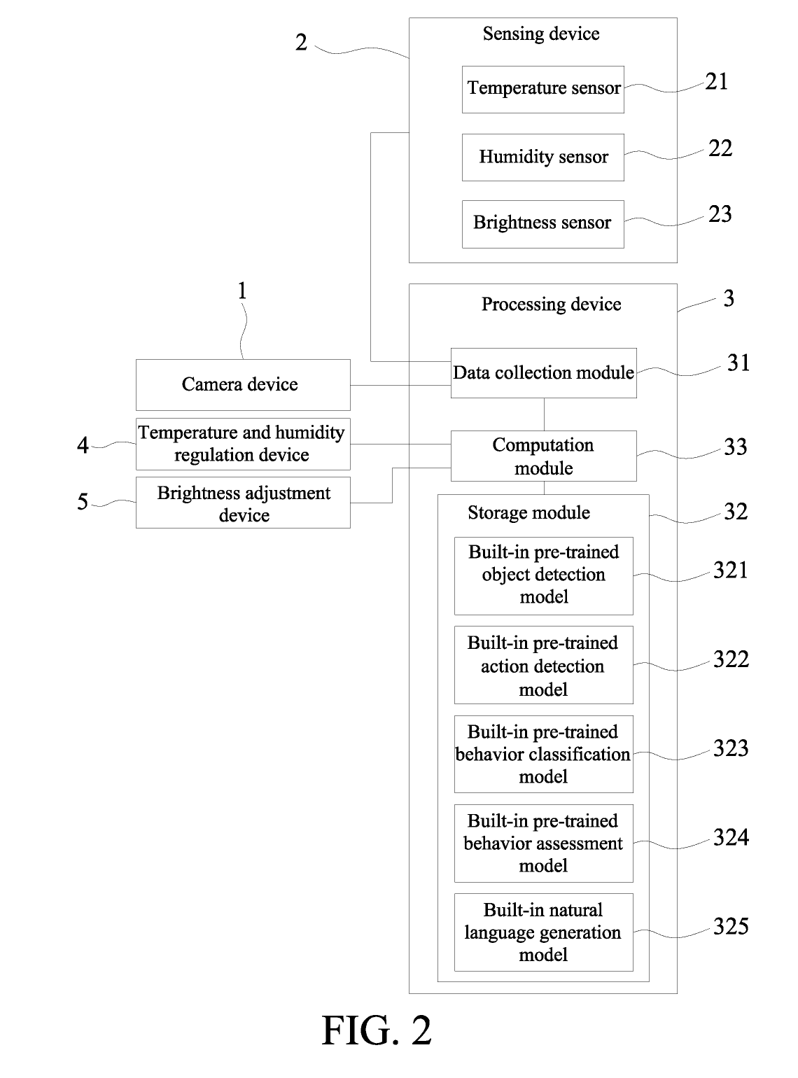

Referring to FIG. 2, a second embodiment of the generative training scenario simulation testing system according to this disclosure is also adapted to be used at the test site, and also includes the camera device 1, the sensing device 2, the processing device 3, the temperature and humidity regulation device 4, and the brightness adjustment device 5.

The second embodiment differs from the first embodiment in that, in the second embodiment, the storage module 32 stores, in addition to the prompt template and the standard environment data, the SOP information, the efficiency evaluation algorithm, a built-in pre-trained object detection model 321, a built-in pre-trained action detection model 322, a built-in pre-trained behavior classification model 323, a built-in pre-trained behavior assessment model 324, and a built-in NLG model 325.

Similar to the pre-trained models 911-914 and 921 of the first embodiment, in the second embodiment, the built-in pre-trained object detection model 321 may be implemented using conventional object detection algorithms such as YOLO or Faster R-CNN; the built-in pre-trained action detection model 322 may be implemented using conventional open-source tools such as OpenPose or Mediapipe; the built-in pre-trained behavior classification model 323 may be developed based on conventional deep learning models such as CNNs or RNNs; the built-in pre-trained behavior assessment model 324 may be developed based on an LSTM network model; the efficiency evaluation algorithm may employ a DTW method; the built-in NLG model 325 may be implemented using a conventional GPT model combined with a mechanical-domain corpus, and fine-tunes prompts through tools provided by the ChatGPT API to generate different text-based exams.

In operation, the data collection module 31 receives the test image from the camera device 1, and receives at least one of the temperature data, the humidity data or the brightness data from the sensing device 2. Then, the computation module 33 receives the test image and the at least one of the temperature data, the humidity data or the brightness data from the data collection module 31.

Subsequently, the computation module 33 controls the temperature and humidity regulation device 4 and/or the brightness adjustment device 5 based on the standard environmental data and the at least one of the temperature data, the humidity data or the brightness data, thereby adjusting the temperature, the humidity, and/or the brightness of the test site to simulate the temperature, the humidity, and/or the brightness of the standard test site.

The computation module 33 uses the built-in pre-trained object detection model 321, the built-in pre-trained action detection model 322, the built-in pre-trained behavior classification model 323, and the built-in pre-trained behavior assessment model 324 to jointly generate an assessment result based on the test image and the SOP information.

Then, the computation module 33 uses the built-in NLG model 325 to generate a text-based exam based on the prompt template and the assessment result.

Similar to the first embodiment, the second embodiment is also capable of detecting “incorrectness” or “non-proficiency” occurring in test images of practical operations, and dynamically generating the text-based exam corresponding to the trainee, thereby effectively reinforcing training focus and enhancing learning effectiveness. The assessment result and the text-based exam may be used to verify the practical operation capability and background knowledge of the trainee, thereby enabling more efficient training and assessment of the trainee.

In summary, the embodiments of the generative training scenario simulation testing system according to this disclosure include a computerized system (e.g., the processing device 3, the first server end 91 and the second server end 92 in the first embodiment, or the processing device 3 in the second embodiment) receiving the test image from the camera device 1, using the pre-trained models 911-914 or 321-324 to generate the assessment result, and using the NLG model 921 or 325 to generate the text-based exam, thereby verifying the practical operation capability and background knowledge of the trainee, and enabling more efficient training and assessment of the trainee. Furthermore, by virtue of the sensing device 2 generating the temperature data, the humidity data, and/or the brightness data, the processing device 3 may control the temperature and humidity regulation device 4 and the brightness adjustment device 5 to regulate the temperature, humidity, and/or brightness of the test site, thereby simulating the temperature, humidity, and/or brightness of the standard test site, and thereby efficiently training and testing the trainee.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A generative training scenario simulation testing system to be used at a test site, said generative training scenario simulation testing system being communicatively coupled to a first server end and a second server end, the first server end storing a pre-trained object detection model, a pre-trained action detection model, a pre-trained behavior classification model, a pre-trained behavior assessment model, and standard operating procedure (SOP) information, the second server end storing a natural language generation (NLG) model,
said generative training scenario simulation testing system comprising:
a camera device disposed at the test site, and configured to capture a test image corresponding to the test site in real time; and
a processing device including a data collection module communicatively coupled to said camera device for receiving the test image, a storage module storing a prompt template, and a computation module electrically coupled to said data collection module and said storage module and communicatively coupled to the first server end and the second server end,
wherein said computation module is configured to receive the test image from said data collection module, transmit the test image to the first server end, and receive an assessment result from the first server end,
wherein the assessment result is generated based on the test image in relation to the SOP information, jointly by the pre-trained object detection model, the pre-trained action detection model, the pre-trained behavior classification model, and the pre-trained behavior assessment model, and
wherein said computation module is configured to transmit the prompt template and the assessment result to the second server end, and receive a text-based exam from the second server end, the text-based exam being generated based on the prompt template and the assessment result by the NLG model.

2. The generative training scenario simulation testing system as claimed in claim 1, further comprising:
a temperature sensor disposed at the test site, and configured to sense a temperature of the test site in real time, and to generate temperature data corresponding to the temperature of the test site thus sensed; and
a temperature and humidity regulation device disposed at the test site, and communicatively coupled to said computation module,
wherein said data collection module is communicatively coupled to said temperature sensor for receiving the temperature data, and
wherein said computation module is configured to receive the temperature data from said data collection module, and to control said temperature and humidity regulation device based on the temperature data, thereby adjusting the temperature of the test site.

3. The generative training scenario simulation testing system as claimed in claim 1, further comprising:
a humidity sensor disposed at the test site, and configured to sense a humidity of the test site in real time, and to generate humidity data corresponding to the humidity of the test site thus sensed; and
a temperature and humidity regulation device disposed at the test site, and communicatively coupled to said computation module,
wherein said data collection module is communicatively coupled to said humidity sensor for receiving the humidity data, and
wherein said computation module is configured to receive the humidity data from said data collection module, and to control said temperature and humidity regulation device based on the humidity data, thereby adjusting the humidity of the test site.

4. The generative training scenario simulation testing system as claimed in claim 1, further comprising:
a brightness sensor disposed at the test site, and configured to sense a brightness of the test site in real time, and to generate brightness data corresponding to the brightness of the test site thus sensed; and
a brightness adjustment device disposed at the test site, and communicatively coupled to said computation module,
wherein said data collection module is communicatively coupled to said brightness sensor for receiving the brightness data,
wherein said computation module is configured to receive the brightness data from said data collection module, and to control said brightness adjustment device based on the brightness data, thereby adjusting the brightness of the test site.

5. A generative training scenario simulation testing system to be used at a test site, comprising:
a camera device disposed at the test site, and configured to capture a test image corresponding to the test site in real time; and
a processing device including:
a data collection module communicatively coupled to said camera device for receiving the test image;
a storage module storing a prompt template, standard operating procedure (SOP) information, a built-in pre-trained object detection model, a built-in pre-trained action detection model, a built-in pre-trained behavior classification model, a built-in pre-trained behavior assessment model, and a built-in natural language generation (NLG) model; and
a computation module electrically coupled to said data collection module and said storage module,
wherein said computation module is configured to receive the test image from said data collection module, and to use the built-in pre-trained object detection model, the built-in pre-trained action detection model, the built-in pre-trained behavior classification model, and the built-in pre-trained behavior assessment model to jointly generate an assessment result based on the test image in relation to the SOP information, and
wherein said computation module is configured to use the built-in NLG model to generate a text-based exam based on the prompt template and the assessment result.

6. The generative training scenario simulation testing system as claimed in claim 5, further comprising:
a temperature sensor disposed at the test site, and configured to sense a temperature of the test site in real time, and to generate temperature data corresponding to the temperature of the test site thus sensed; and
a temperature and humidity regulation device disposed at the test site, and communicatively coupled to said computation module,
wherein said data collection module is communicatively coupled to said temperature sensor for receiving the temperature data, and
wherein said computation module is configured to receive the temperature data from said data collection module, and to control said temperature and humidity regulation device based on the temperature data, thereby adjusting the temperature of the test site.

7. The generative training scenario simulation testing system as claimed in claim 5, further comprising:
a humidity sensor disposed at the test site, and configured to sense a humidity of the test site in real time, and to generate humidity data corresponding to the humidity of the test site thus sensed; and
a temperature and humidity regulation device disposed at the test site, and communicatively coupled to said computation module,
wherein said data collection module is communicatively coupled to said humidity sensor for receiving the humidity data, and
wherein said computation module is configured to receive the humidity data from said data collection module, and to control said temperature and humidity regulation device based on the humidity data, thereby adjusting the humidity of the test site.

8. The generative training scenario simulation testing system as claimed in claim 5, further comprising:
a brightness sensor disposed at the test site, and configured to sense a brightness of the test site in real time, and to generate brightness data corresponding to the brightness of the test site thus sensed; and
a brightness adjustment device disposed at the test site, and communicatively coupled to said computation module,
wherein said data collection module is communicatively coupled to said brightness sensor for receiving the brightness data,
wherein said computation module is configured to receive the brightness data from said data collection module, and to control said brightness adjustment device based on the brightness data, thereby adjusting the brightness of the test site.

9. A generative training scenario simulation testing system to be used at a test site, comprising:
a camera device disposed at the test site, and configured to capture a test image corresponding to the test site in real time, wherein the test image shows a trainee undergoing a simulated mechanical maintenance training at the test site; and
a computerized system communicatively coupled to said camera device for receiving the test image, and storing a prompt template, a pre-trained object detection model, a pre-trained action detection model, a pre-trained behavior classification model, a pre-trained behavior assessment model, standard operating procedure (SOP) information related to the simulated mechanical maintenance training, and a natural language generation (NLG) model,
wherein said computerized system is configured to use the pre-trained object detection model, the pre-trained action detection model, the pre-trained behavior classification model, and the pre-trained behavior assessment model to generate an assessment result based on the test image in relation to the SOP information, and
wherein said computerized system is configured to use the NLG model to generate a text-based exam based on the prompt template and the assessment result, and to perceivably output the text-based exam for the trainee to answer.

10. The generative training scenario simulation testing system as claimed in claim 9, wherein the simulated mechanical maintenance training is classified into multiple operation steps in the SOP information,
wherein said computerized system is configured to use the pre-trained object detection model to identify an object feature appearing in the test image during a specific time interval,
wherein said computerized system is configured to use the pre-trained action detection model to identify an action feature appearing in the test image during the specific time interval,
wherein said computerized system is configured to use the pre-trained behavior classification model to classify, based on the object feature and the action feature respectively identified by the pre-trained object detection model and the pre-trained action detection model, the specific time interval into one of the multiple operation steps in the SOP information, and
wherein said computerized system is configured to use the pre-trained behavior assessment model to determine whether a behavior feature jointly derived from the object feature and the action feature conforms to said one of the multiple operation steps in the SOP information, and to generate the assessment result indicating a result of determining whether the behavior feature conforms to said one of the multiple operation steps in the SOP information.

11. The generative training scenario simulation testing system as claimed in claim 10, wherein said computerized system is configured to, in response to the assessment result indicating that the behavior feature does not conform to said one of the multiple operation steps in the SOP information, use the NLG model to generate the text-based exam based on the prompt template and the assessment result.

12. The generative training scenario simulation testing system as claimed in claim 11, wherein said computerized system stores an efficiency evaluation algorithm, and is configured to, in response to the assessment result indicating that the behavior feature conforms to said one of the multiple operation steps in the SOP information, use the efficiency evaluation algorithm to calculate a degree of temporal matching between an operation time of the trainee during the specific time interval and a time defined in the SOP information with respect to said one of the multiple operation steps in the SOP information, and
wherein said computerized system is configured to, in response to the degree of temporal matching is not greater than a predetermined threshold, use the NLG model to generate the text-based exam based on the prompt template and the assessment result.

13. The generative training scenario simulation testing system as claimed in claim 9, wherein said computerized system includes:
a first server end storing the pre-trained object detection model, the pre-trained action detection model, the pre-trained behavior classification model, the pre-trained behavior assessment model, and the SOP information;
a second server end storing the NLG model; and
a processing device communicatively coupled to said first server end and said second server end,
wherein said processing device includes a data collection module communicatively coupled to said camera device for receiving the test image, a storage module storing the prompt template, and a computation module electrically coupled to said data collection module and said storage module and communicatively coupled to said first server end and said second server end,
wherein said computation module is configured to receive the test image from said data collection module, transmit the test image to said first server end, and receive an assessment result from said first server end,
wherein said first server end is configured to use the pre-trained object detection model, the pre-trained action detection model, the pre-trained behavior classification model, and the pre-trained behavior assessment model to jointly generate the assessment result based on the test image in relation to the SOP information,
wherein said computation module is configured to transmit the prompt template and the assessment result to said second server end, and receive the text-based exam from said second server end, and
wherein said second server end is configured to use the NLG model to generate the text-based exam based on the prompt template and the assessment result.

14. The generative training scenario simulation testing system as claimed in claim 9, wherein said computerized system is a processing device including:
a data collection module communicatively coupled to said camera device for receiving the test image;
a storage module storing the prompt template, the SOP information, the pre-trained object detection model, the pre-trained action detection model, the pre-trained behavior classification model, the pre-trained behavior assessment model, and the NLG model; and
a computation module electrically coupled to said data collection module and said storage module,
wherein said computation module is configured to receive the test image from said data collection module, and to use the pre-trained object detection model, the pre-trained action detection model, the pre-trained behavior classification model, and the pre-trained behavior assessment model to jointly generate the assessment result based on the test image in relation to the SOP information, and
wherein said computation module is configured to use the NLG model to generate the text-based exam based on the prompt template and the assessment result.

15. The generative training scenario simulation testing system as claimed in claim 9, further comprising a temperature sensor disposed at the test site, and configured to sense a temperature of the test site in real time, and to generate temperature data corresponding to the temperature of the test site thus sensed; and
a temperature and humidity regulation device disposed at the test site, and communicatively coupled to said computerized system,
wherein said computerized system is communicatively coupled to said temperature sensor for receiving the temperature data, stores data of a temperature of a standard test site, and is configured to control said temperature and humidity regulation device to adjust the temperature of the test site based on the temperature data received from said temperature sensor and the data of the temperature of the standard test site.

16. The generative training scenario simulation testing system as claimed in claim 9, further comprising:
a humidity sensor disposed at the test site, and configured to sense a humidity of the test site in real time, and to generate humidity data corresponding to the humidity of the test site thus sensed; and
a temperature and humidity regulation device disposed at the test site, and communicatively coupled to said computerized system,
wherein said computerized system is communicatively coupled to said humidity sensor for receiving the humidity data, stores data of a humidity of a standard test site, and is configured to control said temperature and humidity regulation device to adjust the humidity of the test site based on the humidity data received from said humidity sensor and the data of the humidity of the standard test site.

17. The generative training scenario simulation testing system as claimed in claim 9, further comprising:
a brightness sensor disposed at the test site, and configured to sense a brightness of the test site in real time, and to generate brightness data corresponding to the brightness of the test site thus sensed; and
a brightness adjustment device disposed at the test site, and communicatively coupled to said computerized system,
wherein said computerized system is communicatively coupled to said brightness sensor for receiving the brightness data, stores data of a brightness of a standard test site, and is configured to control said brightness adjustment device to adjust the brightness of the test site based on the brightness data received from said brightness sensor and the data of the brightness of the standard test site.
